(19) United States
(12) Patent Application Publication
(10) Pub. No.: US 2006/0252652 A1
(43) Pub. Date: Nov. 9, 2006

(54) Oil base fluids containing hydrophilic tannins

(76) Inventor: Jack C. Cowan, Lafayette, LA (US)

Correspondence Address: ROY F. HOUSE, 5726 ETTRICK STREET, HOUSTON, TX, 77035, US

(21) Appl. No.: 10/571,442

(22) PCT Filed: Oct. 13, 2004
(86) PCT No.: PCT/US04/33780

§ 371 Date: Mar. 13, 2006

Related U.S. Application Data
(60) Provisional application No. 60/514,759, filed on Oct. 27, 2003.

(51) Int. Cl. C09K 8/502

(52) U.S. Cl. 507/206; 507/106; 507/117; 507/219

(57) ABSTRACT

The invention provides oil base well drilling and servicing fluids (OBWDSF) containing a hydrophilic tannin to decrease the fluid loss of the OBWDSF. The hydrophilic tannin, which may be sulfited, is preferably selected from the group consisting of quebracho, wattle, and mixtures thereof. The OBWDSF will contain from about 50% to about 100% by volume of a continuous oil phase, and generally will contain up to about 50% by volume of a discontinuous, emulsified aqueous phase. The OBWDSF can also contain other fluid loss control additives other than the hydrophilic tannin, preferably selected from the group consisting of resins, synthetic polymers, Gilsonite, organophilic polyphenolic compounds, and mixtures thereof. The invention also provides a method of decreasing the fluid loss from an OBWDSF which comprises incorporating into the OBWDSF a hydrophilic tannin.

### FIELD OF THE INVENTION

The invention relates to oil base drilling and well servicing fluids, and to a method of reducing the loss of fluid therefrom to subterranean formations contacted by the fluids.

### BACKGROUND OF THE INVENTION

In the drilling of wells for oil and gas by the rotary method, it is common to use a circulating fluid which is pumped down to the bottom of the well through a drill pipe, where the fluid emerges through ports in the drilling bit. The fluid rises to the surface in the annular space between the drill pipe and the walls of the hole, and at the surface it is treated to remove cuttings and the like to prepare it for recirculation into the drill pipe. The circulation is substantially continuous while the drill pipe is rotated.

The present invention pertains to oil base drilling fluids or oil base muds which includes water-in-oil (invert) emulsions as well as oil base fluids containing only small amounts or no emulsified water. An important feature of well working fluids of the class described is their ability to resist filtration. In most instances, when they are in actual use, whether as drilling fluids, packer fluids, fracturing or completion fluids, the well working fluid is in contact with a more or less permeable formation, such as, for example, sandstone, sandy shale and the like, with an effective balance of pressure such that the fluid tends to be forced into the permeable formation. When a well working fluid is deficient in its ability to resist filtration, then the solids in the fluid are held back by the permeable formation and build up as a filter cake or sludge on its surfaces, while the liquid per se of the well working fluid filters into the permeable formation. The filter cake or sludge thus formed is generally very undesirable. Moreover, the loss of oil to the formation is very expensive, not only because of the cost of the oil itself, but also due to the cost of maintaining the properties and composition of the fluid.

Various additives have been used or suggested for use as fluid loss additives to prevent or decrease this loss of fluid by filtration from oil base muds. Some of the first materials used for this purpose were asphalt and various modified asphaltic materials. The following patents disclose various amine derivatives of various polyphenolic compounds for use as fluid loss control additives (hereinafter sometimes referred to as FLCA) for oil muds: Jordan et al. U.S. Pat. No. 3,168,475; Jordan et al. U.S. Pat. No. 3,281,458; Beasley et al. U.S. Pat. No. 3,379,650; Cowan et al. U.S. Pat. No. 3,232,870; Cowan et al. U.S. Pat. No. 3,425,953; Andrews et al. U.S. Pat. No. 3,494,865; Andrews et al. U.S. Pat. No. 3,671,427; Andrews et al. U.S. Pat. No. 3,775,447; Kim U.S. Pat. No. 3,538,071; Kim U.S. Pat. No. 3,671,428; Cowan U.S. Pat. No. 4,421,655; Connell et al. U.S. Pat. No. 4,501,672; House U.S. Pat. No. 4,569,799; House et al. U.S. Pat. No. 4,597,878; Patel U.S. Pat. Nos. 4,637,883 and 4,710,586; Cowan et al. U.S. Pat. Nos. 4,737,295 and 4,853,465; Patel U.S. Pat. No. 5,990,050; and Frost European Pat. Application No. 049,484.

Cowan U.S. Pat. No. 4,421,655 discloses organophilic derivatives of polyphenolic compounds wherein the polyphenolic compound may be modified tannins and the oxidized, sulfonated, and sulfomethylated derivatives thereof, and wherein the organophilic modifier is a polyamine or polyamidoamine which contain at least two primary, secondary, or tertiary amine groups per molecule selected from the group consisting of:

(I) R—NR′—(CₓH₂ₓN′)_{y}H

(II) R—CO—NH—(CₓH₂ₓNR′)_{z}H 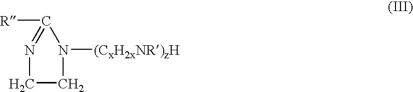
where 2≦x≦3; y≧1z≧2; R is an aliphatic group containing from 12 to 30 carbon atoms; R′ is selected from the group consisting of H and R″—CO, and mixtures thereof; R″ is an aliphatic group containing from 11 to 29 carbon atoms; and wherein at least two of the R′ groups are H.

House U.S. Pat. No. 4,569,799 discloses a process of preparing organophilic derivatives of polyphenolic acids including modified tannins and the oxidized, sulfonated, and sulfomethylated derivatives of the polyphenolic compounds.

House et al. U.S. Pat. No. 4,597,878 discloses certain organophilic polyphenolic acid adducts wherein the polyphenolic acid may be derived from tannins such as quebracho, sulfonated quebracho, carboxylated quebracho, oxidized quebracho, and the like, and wherein the organophilic modifier is an amide mixture of a polyamide containing no free amino groups and an amido-amine containing one free amino group per molecule.

Patel et al. U.S. Pat. Nos. 4,637,883 and 4,710,586 disclose alkyl quaternary ammonium salts of quebracho.

Cowan et al. U.S. Pat. Nos. 4,737,295 and 4,853,465 disclose organophilic polyphenolic materials wherein the polyphenolic material may be tannins or the oxidized, sulfonated, or sulfomethylated derivatives thereof, and wherein the organophilic modifier is a phosphatide, preferably lecithin.

Patel U.S. Pat. No. 5,990,050 discloses an invert emulsion fluid which may contain a fluid loss control agent such as organophilic tannins prepared by reacting tannic acid with amides or polyalkylene polyamines.

As noted in the examples in the aforementioned patents, the amount of the organic amine or amide compounds reacted with the polymeric phenolic compounds disclosed is quite high, generally of the order of 30%-100% or more, based on the weight of the polymeric phenolic compound, although amounts from 20% to 200% are disclosed to be useful. Most of these FLCA possess poor dispersibility in well working fluids unless elaborate procedures are undertaken, such as the addition of a dispersant, heating, agitating under high shear or for extended periods of time, drying under low temperature conditions, flushing, preparation in oleaginous liquids, and the like. Moreover, the amine and amide compounds are relatively expensive to prepare and/or purchase, and thus these FLCA are quite expensive to produce.

### SUMMARY OF TIHE INVENTION

I have now surprisingly found that the addition of hydrophilic tannins to oil base well drilling and servicing fluids or muds (hereinafter sometimes referred to as “OBWDSF”) will function as fluid loss control additives to decrease the loss of fluid therefrom.

Thus it is an object of this invention to provide oil base well drilling and servicing fluids containing a hydrophilic tannin to decrease the fluid loss therefrom.

It is another object of the invention to provide a method of decreasing the fluid loss of an oil base well drilling and servicing fluid.

These and other objects of this invention will be apparent to one skilled in the art upon reading this specification and the appended claims.

While the invention is susceptible of various modifications and alternative forms, specific embodiments there of will hereinafter be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

The composition can comprise, consist essentially of, or consist of the stated materials. This method can comprise, consist essentially of, or consist of the stated steps with the stated materials.

### PREFERRED EMBODMENTS OF THE INVENTION

The present invention provides for the addition of hydrophilic tannins to oil base well drilling and servicing fluids to decrease the loss of fluid therefrom. OBWDSF may be prepared by a great variety of formulations with a large number of ingredients, as is well known to those skilled in the art. Specific formulations depend on the state of drilling a well at any particular time, for instance, depending on the depth, the nature of the strata encountered, and the like. The compositions of this invention are directed to and adapted to provide improved, economical OBWDSF useful under conditions of high temperature and pressure, such as those encountered in deep wells, where many previously proposed and used formulations do not heat age well, and there is an unacceptable fluid loss noted after operations under such high temperature and high pressure conditions.

THE OBWDSF of the invention will contain a liquid phase which contains from 100% oil to about 50% oil as is known in the art. Included are emulsions comprising water-in-oil (w/o) invert emulsions where the continuous phase is an oil having the discontinuous water phase dispersed and emulsified therein.

Generally the water phase comprises from about 2% to about 50% by volume of the combined oleaginous and aqueous phases.

The oil used may be any of the known oleaginous liquids used in the art. Exemplary oils are petroleum oils, such as diesel oil, mineral oils, hydrotreated petroleum oils and the like, synthetic hydrocarbons such as alpha olefins, polyalpha olefins, internally unsaturated olefins, and the like, and synthetic esters and ethers and the like.

Invert (w/o) base mud formulations intended for use under high temperature (up to about 250° C.) and high pressure (up to about 172,500 kPa (25,000 psi)) conditions normally will contain an oil, a weighting agent, an emulsifier, a gelling agent, salts, and a fluid loss control agent, as essential ingredients. Water is often added but it may be introduced from the formations themselves during drilling.

The W/O emulsion OBWDSF contain one or more emulsifiers as is well known in the art, including alkali and alkaline earth metal salts of fatty acids, rosin acids, tall oil acids, the synthetic emulsifiers such as alkyl aromatic sulfonates, aromatic alkyl sulfonates, long chain sulfates, oxidized tall oils, carboxylated 2-alkyl imidazolines, imidazoline salts, and the like.

Water soluble salts are added to the formulations containing water, normally the brine salts such as sodium chloride, potassium chloride, sodium bromide, calcium chloride most preferably, and the like, normally in a small amount of water. These salts are added to control the osmotic pressure of the formulations as needed, according to drilling conditions.

Gelling agents include the activated clays, organophilic clays such as bentonite which may have had the surface treated as with quaternary ammonium salts, fatty amines and the like and other gelling or thickening agents such as alkali metal soaps, asphaltic materials, mineral fibers and the like.

Weighting materials include such materials as calcium carbonate, silicates, clays, and the like, but more preferably are the heavier minerals such as the barites, specular hematite, iron ores, siderite, ilmenite, galena, and the like.

These muds normally will be formulated to weigh from greater than 930 kg/m³ (no weighting agent) to about 2640 kg/m³ (7.75 to 22 ppg) of mud. Usually the range is from about 1200 kg/m³ to about 2160 kg/m³ (10 to 1 8 ppg).

The fluid loss control agents useful in the OBWDSF of this invention are, and indeed are required to be, hydrophilic tannin materials. The vegetable tannins are well known polyphenols which are extracted from various plants. They can be divided into two categories: catechol tannins, otherwise know as condensed tannins, which are chemically similar to catechol; and pyrogallol tannins, otherwise known as hydrolysable tannins, which are chemically esters of glucose and gallic acid. Exemplary of catechol tannins are extracts from the following trees: quebracho, wattle, mimosa, pine, mangrove, eucalyptus, and hemlock. Exemplary of pyrogallol tannins are extracts from the following trees: chestnut, sumac, valonia, and myrabolan. Extracts from oak trees contain both kinds of tannins.

The preferred tannins are unmodified water/steam extracted tannins. However, hydrophilic sulfited or sulfomethylated vegetable tannins can be utilized as the fluid loss additive in OBWDSF. Such sulfited tannins are well known in the art and are usually prepared by reacting the tannin materials with sulfic acid whereby the extracts acquire SO₃H⁻ groups. This transforms them into a more readily water soluble tannin.

The preferred tannins are catechol tannins, most preferably selected from the group consisting of quebracho, wattle, or mixtures thereof.

Commercially available tannins are mixtures of tannins, non-tannin other extractables, insoluble materials, and of course moisture. For the purpose of this invention, the hydrophilic tannins shall contain greater than about 50% by weight tannin, preferably greater than about 60% tannin.

The concentration of the hydrophilic tannin fluid loss control agents in the OBWDSF of this invention generally comprises from about 5.7 kg/m³ to about 85.7 kg/m³ (i.e., about 2 to about 30 ppb), preferably from about 14.3 kg/m³ to about 57.1 kg/m³ (5 to 20 ppb). The amount should be sufficient to decrease the API HTHP filtrate of the OBWDSF at 121.1° C. (250° F.) or higher temperatures and 3450 kPa (500 psi) by about 40%, preferably at least about 50%, of the fluid loss of the OBWDSF before adding the hydrophilic tannin.

The OBWDSF are generally prepared by mixing the emulsifier(s), if used, with the oleaginous liquid, mixing in the aqueous liquid, if used, mixing in the gelling agent (Theological modifier), mixing in the hydrophilic tannin fluid loss control agent, followed by mixing in the weighting material. The OBWDSF may also contain a dispersant for the gelling agent such as a low molecular weight polar organic compound when the gelling agent is an organophilic clay. This is generally added after the gelling agent is well mixed into the formulation.

The invention also provides OBWDSF which contain known fluid loss control agents together with the hydrophilic tannin fluid loss control agents set forth herein. It has been determined that the fluid loss from OBWDSF containing known fluid loss control additives can be further substantially decreased by the addition thereto of the hydrophilic tannins set forth hereinbefore.

Known fluid loss control, agents/additives used or proposed for use in OBWDSF include various asphaltic materials, resins, synthetic polymers, Gilsonite, and organophilic polyphenolic compounds such as organophilic lignites, organophilic humic acids, organophilic tannins, and the like. Representative of the organophilic polyphenolic compounds are those set forth in the following patents, all of which are incorporated herein by reference: Jordan et al. U.S. Pat. No. 3,168,475; Jordan et al. U.S. Pat. No. 3,281,458; Beasley et al. U.S. Pat. No. 3,379,650; Cowan et al. U.S. Pat. No. 3,232,870; Cowan et al. U.S. Pat. No. 3,425,953; Andrews et al. U.S. Pat. No. 3,494,865; Andrews et al. U.S. Pat. No. 20 3,671,427; Andrews et al. U.S. Pat. No. 3,775,447; Kim U.S. Pat. No. 3,538,071; Kim U.S. Pat. No. 3,671,428; Cowan U.S. Pat. No. 4,421,655; Connell et al. U.S. Pat. No. 4,501,672; House U.S. Pat. No. 4,569,799; House et al. U.S. Pat. No. 4,597,878; Patel U.S. Pat. Nos. 4,637,883 and 4,710,586; Cowan et al. U.S. Pat. Nos. 4,737,295 and 4,853,465; Patel U.S. Pat. No. 5,990,050; and Frost European Pat. Application No. 049,484.

The concentration of the hydrophilic tannin fluid loss control additive in the OBWDSF containing one or more known fluid loss control additives will be an amount sufficient to decrease the fluid loss of the OBWDSF as measured by one or more of the industry standard tests as set forth in API Recommended Practice RP-13B-1. Generally the concentration of hydrophilic tannin will be from about 0.285 kg/m³ (0.1 ppb) to about 57.1 kg/m³ (20 ppb), preferably from about 0.57 kg/M³ (0.2 ppb) to about 42.8 kg/m³ (15 ppb), and most preferably from about 0.71 kg/m³ (0.25 ppb) to about 28.5 kg/m³ (10 ppb).

The invention also provides a method of decreasing the fluid loss from an OBWDSF, including OBWDSF containing known fluid loss control additives, which comprises incorporating into the OBWDSF as disclosed hereinbefore an amount of a hydrophilic tannin to decrease the fluid loss of the OBWDSF. The amount preferably should be sufficient to decrease the API HTHP filtrate of the OBWDSF at 121.1° C. (250° F.) or higher temperatures by about 40%, preferably at least about 50%, of the fluid loss of the OBWDSF before adding the hydrophilic tannin or known fluid loss control additive. Generally this will comprise from about 0.285 kg/m³ (0.1 ppb) to about 57.1 kg/m³ (20 ppb), preferably from about 0.57 kg/m³ (0.2 ppb) to about 42.8 kg/m³ (15 ppb), and most preferably from about 0.71 kg/m³ (0.25 ppb) to about 28.5 kg/m³ (10 ppb). Exemplary hydrophilic tannins are as hereinbefore set forth.

In order to more completely describe the invention, the following non-limiting examples are given. In these examples and this specification, the following abbreviations may be used: ppg=pounds per gallon; ppb=pounds per 42 gallon barrel; psi=pounds per square inch; cm³=cubic centimeters; kg/m3=kilogram/cubic meter; kPa=kilopascal; Pa=pascal; ml=milliliters; g=grams; cp=centipoise; rpm=revolutions per minute; sq.ft.=square feet; sec=seconds; min=minutes; W/O=water-in-oil; FLCA=fluid loss control additive; OBWDSF=oil base well drilling and servicing fluid; API HTHP filtrate=American Petroleum institute high temperature high pressure filtrate as set forth in API Recommended Practice RP 13B-1.

### EXAMPLE 1

An invert w/o base fluid was prepared by mixing together the following components in the order indicated, with a five minute mixing time after each addition and a final ten minute mixing time after the barite addition: 7110 ml diesel oil; 150 g CARBO-GEL organophilic clay gelling agent/rheological modifier; 30 ml propylene carbonate organoclay dispersant; 150 ml CARBO-TEQ emulsifier; 240 ml CARBO-MUL emulsifier, 90 g lime; 1770 ml of a 30% by weight calcium chloride solution; and 6870 g barite weighting agent. The CARBO-GEL, CARBO-TEQ, and CARBO-MUL are products of Baker Hughes Inteq, Houston, Tex.

To 350 ml (one barrel equivalent) of this base fluid were added the concentrations of Quebracho TB (obtained from Unitan SA, Buenos Aires, Argentina) and VEN-CHEM 222, an organophilic lignite fluid loss additive (obtainable from Venture Chemicals, Inc., Lafayette, La.) set forth in Table 1 and the fluids were thereafter mixed ten minutes on an Osterizer high shear blender. The muds were hot rolled at 176.7° C. (350° F.) and 3450 kPa (500 psi) differential pressure for 16 hours, cooled to room temperature, mixed ten minutes on an Osterizer blender at high shear, and evaluated for the Fann Rheology, emulsion stability, and HTHP API fluid loss at 176.7° C. (3500F) and 3450 kPa (500 psi) differential pressure by the procedures in API Recommended Practice RP 13B-1.

The data obtained are in Table 1. Fluid 1-A and 1-B are for comparison purposes only.

TABLE 1
Effect of Quebracho on the Fluid Loss of an Oil Base Mud

| Fluid | 1-A | 1-1 | 1-2 | 1-3 | 1-4 | 1-B |
|---|---|---|---|---|---|---|
| Oil Base Mud, ml | 350 | 350 | 350 | 350 | 350 | 350 |
| Quebracho, g | 0 | 5 | 10 | 0.6 | 1.2 | 0 |
| VEN-CHEM 222, g | 0 | 0 | 0 | 14.4 | 13.8 | 15 |

After Hot Rolling for 16 Hours at 176.7° C. (350° F.)
Fann Rheology

| | | | | | | |
|---|---|---|---|---|---|---|
| 600 rpm (Dial reading) | 60 | 84 | 80 | 83 | 123 | 85 |
| 300 rpm (Dial reading) | 31 | 49 | 47 | 44 | 69 | 46 |
| Plastic Viscosity, cP | 29 | 35 | 33 | 39 | 54 | 39 |
| Yield Point, Pa (lb/100 sq.ft.) | 0.96(2) | 6.72(14) | 6.72(14) | 2.4(5) | 7.2(15) | 3.36(7) |
| 10-sec Gel, Pa (lb/100 sq.ft.) | 1.92(4) | 5.28(11) | 5.76(12) | 1.92(4) | 1.92(4) | 1.44(3) |
| 10-min Gel, Pa (lb/100 sq.ft.) | 2.88(6) | 8.64(18) | 8.64(18) | 2.4(5) | 2.88(6) | 2.4(5) |
| Emulsion Stability, v | 535 | 1760 | 2000+ | 509 | 528 | 707 |

Fluid Loss at at 176.7° C. (350° F.), 3450 kPa (500 psi)

| | | | | | | |
|---|---|---|---|---|---|---|
| Fluid Loss, cm³/30 min | 84.8 | 26.8 | 25.2 | 35.6 | 34.4 | 47.2 |
| Free Water, cm³ | 2.4 | 0 | 0 | 0 | 0 | 0 |
| Free Emulsion, cm³ | 10.0 | 0.2 | 0.2 | 1.2 | 0.8 | 4.0 |

### EXAMPLE 2

An oil base mud was prepared by mixing together 90% by volume of the oil base mud set forth in Example 1 and 10% by volume diesel oil. To 350 ml of this oil base mud were added and mixed for ten minutes the quantities of Ven-Chem 208, an organophilic lignite fluid loss additive obtainable from Venture Chemicals, Inc., Lafayette, La., and quebracho set forth in Table 2. The fluids were then hot rolled at 148.9° C. (300° F.) for 16 hours, cooled to room temperature, mixed for five minutes on a Hamilton Beach mixer at low shear, and evaluated as in Example 1. The data obtained are set forth in Table 2. Fluids 2-A and 2-B are for comparison purposes only.

TABLE 2
Effect of Quebracho and an Organophilic Lignite
Derivative on the Fluid Loss of an Oil Base Mud

| Fluid | 2-A | 2-B | 2-1 | 2-2 | 2-3 |
|---|---|---|---|---|---|
| Oil Base Mud, ml | 350 | 350 | 350 | 350 | 350 |
| VEN-CHEM 208, g | 0 | 10 | 9.5 | 9.0 | 8.0 |
| Quebracho, g | 0 | 0 | 0.5 | 1.0 | 2.0 |

Properties After Hot Rolling at 148.9° C. (300° F.) for 16 hours
Farm Rheology

| | | | | | |
|---|---|---|---|---|---|
| 600 rpm (Dial reading) | 45 | 49 | 50 | 53 | 60 |
| 300 rpm (Dial reading) | 23 | 25 | 27 | 28 | 31 |
| Plastic Viscosity, cP | 22 | 24 | 23 | 25 | 29 |
| Yield Point, Pa | 0.48(1) | 0.48(1) | 1.92(4) | 1.44(3) | 0.96(2) |
| (lb/100 sq.ft.) | | | | | |
| 10-sec Gel, Pa | 2.4(5) | 2.4(5) | 2.88(6) | 2.88(6) | 2.88(6) |
| (lb/100 sq.ft.) | | | | | |
| 10-min Gel, Pa | 2.88(6) | 2.88(6) | 4.32(9) | 3.84(8) | 3.84(8) |
| (lb/100 sq.ft.) | | | | | |
| Emulsion Stability, v | 379 | 394 | 433 | 513 | 661 |

Fluid Loss at 148.9° C. (300° F.), 3450 kPa (500 psi)

| | | | | | |
|---|---|---|---|---|---|
| Fluid Loss, cm³/30 min | 23.2 | 13.6 | 6.8 | 7.2 | 7.2 |
| Free Water, cm³ | 0 | 0 | 0 | 0 | 0 |
| Free Emulsion, cm³ | 0.2 | 0.2 | 0 | 0 | 0 |

### EXAMPLE 3

The API fluid loss at 690 kPa (100 psi) and room temperature was determined for various oils containing the quantities of Ven-Chem 222, an organophilic lignite fluid loss control additive obtainable from Venture Chemicals, Inc., Lafayette, La., and quebracho set forth in Table 3. The fluids were mixed for ten minutes on a Hamilton Beach Multimixer. The oils evaluated were diesel oil, BioBase, an internal olefim obtainable from Shrieve Chemical Company, Houston, Tex. and VASSA LP-90, obtainable from Vassa, Estado Falcon, Venezuela

### EXAMPLE 4

The procedures in Example 2 were repeated except that the concentration of the hydrophilic tannins evaluated as fluid loss control additives were 14.2 kg/m³, 28.5 kg/m³, or 42.8 kg/m³ (5, 10, or 15 ppb).

TABLE 3
Effect of Quebracho and an Organophilic Lignite
Derivative on the Fluid Loss of Various Oils

| Fluid | 3-1 | 3-2 | 3-3 | 3-4 | 3-5 |
|---|---|---|---|---|---|
| Diesel Oil, ml | 350 | 350 | 350 | 0 | 0 |
| BioBase, ml | 0 | 0 | 0 | 350 | 0 |
| VASSA LP-90, ml | 0 | 0 | 0 | 0 | 350 |
| VEN-CHEM 222, g | 4.8 | 14.4 | 13.8 | 14.4 | 14.4 |
| Quebracho, g | 0.2 | 0.6 | 1.2 | 0.6 | 0.6 |

API Fluid Loss at 690 kPa (100 psi)

| | | | | | |
|---|---|---|---|---|---|
| cm³/30 min. | 10 | 4 | 3.5 | 42 | 17 |

TABLE 4

| Fluid | 4-A | 4-1 | 4-2 | 4-3 | 4-4 | 4-5 |
|---|---|---|---|---|---|---|
| Oil Base Mud, ml | 350 | 350 | 350 | 350 | 350 | 350 |
| Quebracho, g | 0 | 5 | 10 | 15 | 0 | 0 |
| Sulfited Quebracho, g | 0 | 0 | 0 | 0 | 10 | 0 |
| Wattle Extract, g | 0 | 0 | 0 | 0 | 0 | 10 |

Properties After Hot Rolling for 16 Hours at 148.9° C. (300° F.)
Farm Rheology

| | | | | | | |
|---|---|---|---|---|---|---|
| 600 rpm (Dial reading) | 48 | 65 | 67 | 83 | 59 | 55 |
| 300 rpm (Dial reading) | 27 | 34 | 37 | 47 | 30 | 29 |
| Plastic Viscosity, cP | 21 | 31 | 30 | 36 | 29 | 26 |
| Yield Point, Pa (lb/100 sq.ft.) | 2.88(6) | 1.44(3) | 3.36(7) | 5.28(22) | 0.48(1) | 1.44(3) |
| 10-sec Gel, Pa (lb/100 sq.ft.) | 1.92(4) | 2.4(5) | 3.36(7) | 3.36(7) | 2.88(6) | 2.4(5) |
| 10-min Gel, Pa (lb/100 sq.ft.) | 3.36(7) | 3.84(8) | 3.84(8) | 4.8(10) | 4.8(10) | 3.84(8) |
| Emulsion Stability, v | 337 | 1039 | 1029 | 997 | 841 | 612 |

Fluid Loss at 176.7° C. (350° F.), 3450 kPa (500 psi)

| | | | | | | |
|---|---|---|---|---|---|---|
| Fluid Loss, ml/30 min | 22.4 | 9.6 | 9.2 | 9.2 | 11.2 | 8.0 |
| Free Water, ml | 0.2 | 0 | 0 | 0 | 0 | 0 |
| Free emulsion, ml | 0.2 | 0 | 0 | 0 | 0 | 0 |

What is claimed is:

1. An oil base well drilling and servicing fluid which comprises an oil continuous phase containing a hydrophilic tannin therein in an amount to decrease the fluid loss therefrom.

2. The oil base well drilling and servicing fluid of claim 1 wherein the hydrophilic tannin is selected from the group consisting of quebracho extract, wattle extract, and mixtures thereof.

3. The oil base well drilling and servicing fluid of claim 2 wherein the hydrophilic tannin has been sulfited.

4. The oil base well drilling and servicing fluid of claim 1 which additionally contains a fluid loss control additive other than the hydrophilic tannin.

5. The oil base well drilling and servicing fluid of claim 4 wherein the additional fluid loss control additive is selected from the group consisting of resins, synthetic polymers, Gilsonite, organophilic polyphenolic compounds, and mixtures thereof.

6. The oil base well drilling and servicing fluid of claim 1, 2, 3, 4, or 5 which additionally contains an aqueous phase emulsified into the continuous oil phase, one or more emulsiflers, a rheological modifier, and a weighting agent.

7. The oil base well drilling and servicing fluid of claim 6 wherein the aqueous phase comprises from about 2% to about 50% by volume of the combined liquid phase of the oil base well drilling and servicing fluid.

8. A method of decreasing the fluid loss from an oil base well drilling and servicing fluid which comprises incorporating into the oil base well drilling and servicing fluid a hydrophilic tannin.

9. The method of claim 8 wherein the hydrophilic tannin is selected from the group consisting of quebracho extract, wattle extract, and mixtures thereof.

10. The method of claim 9 the hydrophilic tannin has been sulfited.

11. The method of claim 8 wherein the oil base well drilling and servicing fluid additionally contains a fluid loss control additive other than the hydrophilic tannin.

12. The method of claim 11 wherein the additional fluid loss control additive is selected from the group consisting of resins, synthetic polymers, Gilsonite, organophilic polyphenolic compounds, and mixtures thereof.

13. The method of claim 8, 9, 10, 11, or 12 wherein the oil base well drilling and servicing fluid additionally contains an aqueous phase emulsified into the continuous oil phase, one or more emulsifiers, a Theological modifier, and a weighting agent.

14. The method of claim 13 wherein the aqueous phase comprises from about 2% to about 50% by volume of the combined liquid phases of the oil base well drilling and servicing fluid.
